(19) United States
(12) Patent Application Publication
(10) Pub. No.: US 2025/0384225 A1
(43) Pub. Date: Dec. 18, 2025

(54) REAL-TIME SIMULATOR TO GENERATE REAL-TIME TRANSLATIONS SIMULATING HUMAN EMOTIONS

(71) Applicant: Audi Veras, West Roxbury, MA (US)

(72) Inventor: Audi Veras, West Roxbury, MA (US)

(73) Assignee: Audi Veras, West Roxbury, MA (US)

(21) Appl. No.: 18/746,375

(22) Filed: Jun. 18, 2024

(51) Int. Cl. G06F 40/58

(52) U.S. Cl. CPC G06F 40/58

(57) ABSTRACT

Disclosed are a system and method that provides a real-time translator that provides accurate translations that consider the context of the speaker's emotions and also provides a simulated translation that accounts for the speaker's tone, pitch, treble, bass, voice strain, and volume. The system and method are designed to allow for use in any situation requiring translation in which an audio signal can be heard.

### FIELD

This invention relates to synthetic audio generation and, more specifically, to generating audio translations that mimic the emotional state of the speaker in real time.

### BACKGROUND

Audio translation techniques fall into two categories—human driven and simulation. Human-driven techniques require individuals to listen to and repeat what is being said. These techniques are costly and time consuming, while leaving the translation process up to subjective determinations and talents of the individual translators. Additionally, the techniques often require the translators to concentrate on what is being said and not how it is being said. Thus, there is a loss in context when translations are occurring in real time.

Simulations utilize computer technology to generate a translation and to convert the translation into sound. These techniques however suffer two problems. First, the techniques similar to human translation fail to mimic the emotion of the individual speaking when reproducing the tone and volume of the speaker because prior computer-generated simulations lack the capacity to comprehend how humans speak in a particular context. This is a reason that computer simulations sound synthetic and inauthentic.

Furthermore, computer simulations also fail to translate using proper words from a particular language due to the lack of understanding of context. It is common for languages to have different words for different emotional states. Real-time simulation of language requires a computer translator to identify the proper context, identify the proper words, and identify the proper tone, pitch, and volume.

The present disclosure addresses issues relating to translation techniques by providing a real-time computer translator that provides accurate translations that consider the context of the speaker's emotions and also provides a simulated translation that accounts for the speaker's tone, pitch, treble, and volume.

### SUMMARY

For generations, human translators have been used to translate between individuals. Human translators are still commonly used in media, international events, and at the United Nations. Human translators have long been considered the gold standard for translations.

In the last decade, computer-generated translations of text have become common, including translators on Google, Bing, and other websites. Simulated voice translators have also been available and allow for simulation of various languages. However, these simulations sound robotic and inauthentic to humans and fail in particular to simulate an authentic emotional state.

The present disclosure includes a system and method for translating speech to accurately portray the emotional state of the speaker and to simulate the speaker's emotional state in an audio file. Aspects of the disclosed system include generating a real-time translation from a first language to a second language to maintain emotional fidelity from the first language to the second language. Embodiments of the disclosed system include hardware and software such that the system comprises a sound sensor module configured to sense an audio signal, wherein the system comprises a storage module configured to store an audio file of the first language as it is spoken by a person.

It should be noted that when the disclosure refers to a “second” language, this is from the perspective of the listener. However, from the perspective of the speaker, a plurality of languages can be chosen at any particular time.

Other embodiments include the system further comprising a segregation module activated upon receiving an input from the storage module that the audio file has been received and the segregation module configured to separate the audio file into a plurality of distinct sections, wherein each of the plurality of distinct sections comprises data, said data comprising words and data relating to pitch, tone, emotional state, volume, language tense, speaking speed, and vocal strain.

In further embodiments, the system further comprises a transcription module configured to create a transcript of the plurality of distinct sections and to create a first datafile with details relating to the pitch, tone, emotional state, volume, language tense, speaking speed, and vocal strain identified in each of the plurality of distinct sections.

In more embodiments, the system further comprises a function that permits selection of one or more languages from a list of languages stored in a memory, wherein the system accesses a dataset stored in the memory relating to the second language selected by the user.

In still more embodiments, the system further comprises a second datafile stored in the memory corresponding to pitch, tone, emotional state, volume, language tense, speaking speed, and vocal strain used in the second language, wherein the second datafile is accessible by the system upon selection of the second language.

In yet more embodiments, the system also comprises a translation module that is configured to receive the transcript from the transcription module and further configured to create a translation transcript of the plurality of distinct sections.

In certain embodiments, the system additionally comprises a conversion module that is configured to convert the first datafile into meta information by matching the information in the first datafile with information in the second datafile and combine the meta information with the translation transcript to match the appropriate pitch, tone, emotional state, volume, language tense, speaking speed, and vocal strain identified in each of the plurality of distinct sections.

In yet more embodiments, the system further comprises an accuracy module configured to scan the translation transcript for errors and to correct said errors.

In other embodiments, the system also comprises a simulation module configured to receive the translation transcript and generate a real-time simulation translation matching the pitch, tone, emotional state, volume, language tense, speaking speed, and vocal strain of the person, wherein the simulation module reconstructs the segments into the simulation.

In certain embodiments, the system comprises a mechanism to send the simulation to a device of a user requesting a translation of the speaker.

Aspects disclosed herein include a method of generating a real-time translation from a first language to a second language to maintain emotional fidelity from the first language to the second language. In certain embodiments, the method comprises acquiring and storing an audio file of the first language as it is spoken by a person. In other embodiments, the method further comprises segregating the audio file into a plurality of distinct sections, wherein each of the plurality of distinct sections comprises data, said data comprising words and data relating to pitch, tone, emotional state, volume, language tense, speaking speed, and vocal strain.

In still other embodiments, the method further comprises creating a transcript from each of the plurality of distinct sections.

In more embodiments, the method further comprises creating a first datafile with details relating to the pitch, tone, emotional state, volume, language tense, speaking speed, and vocal strain identified in each of the plurality of distinct sections.

In yet more embodiments, the method further comprises, upon selection of a second language by a user, accessing a dataset relating to the second language, wherein the dataset comprises words.

In still more embodiments, the method further comprises, upon selection by the user of the second language, accessing a second datafile corresponding to pitch, tone, emotional state, volume, language tense, speaking speed, and vocal strain used in the second language.

In certain embodiments, the method further comprises translating the transcript to the second language by matching the transcript with the dataset to create a translation transcript of the plurality of distinct sections.

In more certain embodiments, the method further comprises converting the first datafile into meta information by matching the information in the first datafile with information in the second datafile.

In other embodiments, the method further comprises combining the meta information with the translation transcript to match the appropriate pitch, tone, emotional state, volume, language tense, speaking speed, and vocal strain identified in each of the plurality of distinct sections.

In further embodiments, the method further comprises confirming the accuracy of the translation transcript.

In still further embodiments, the method further comprises generating a real-time simulation matching the pitch, tone, emotional state, volume, language tense, speaking speed, and vocal strain of the person.

In other embodiments, the method further comprises sending the simulation to a device of a user.

These and other important objects, advantages, and features of the disclosed systems and methods are disclosed herein.

### BRIEF DESCRIPTION OF THE DRAWINGS

For a fuller understanding of the invention, reference should be made to the following detailed description, taken in connection with the accompanying drawings, in which:

FIG. 1 is a block diagram of an embodiment of the disclosed system;

FIG. 2 is a block diagram of an embodiment of the disclosed system;

FIG. 3 is a flowchart of an embodiment of the disclosed method.

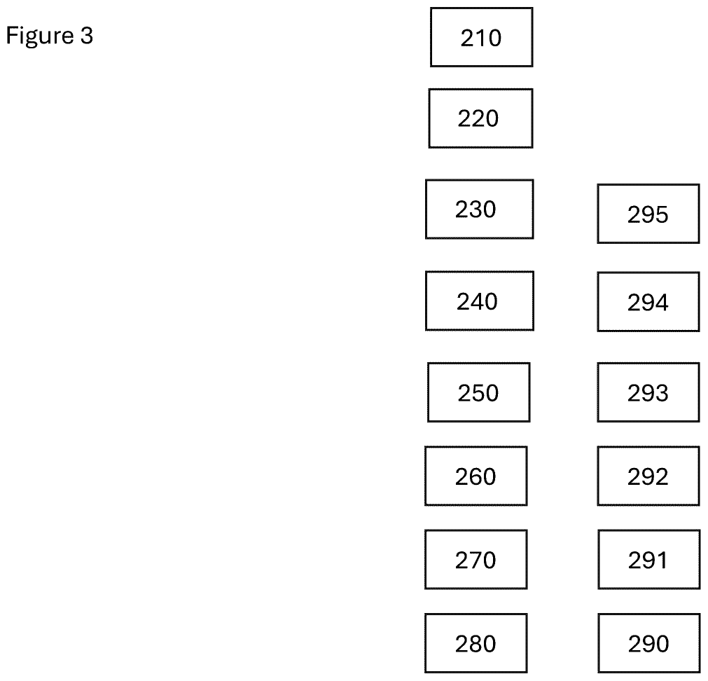

### DETAILED DESCRIPTION

As disclosed herein, reference shall be made to the drawings, and it should be understood that such drawings are not limiting.

As used herein, the term “and” includes any deviation from a numeric term to cover +/−10% of the numeric value. The term “and” is also an open term and does not foreclose additional embodiments.

As used herein, the term “or” means “and/or” unless the context indicates otherwise.

The disclosed systems comprise storage media that include, but are not limited to, diskettes, optical disks, compacts disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or any media that can store audio files and software.

In some embodiments, the systems include a computer that has a memory. In some embodiments, a user interface is utilized, including graphic user interfaces. As disclosed herein, computers include processors that permit the disclosed system to provide real-time translation simulations. In particular embodiments, the computing portion of the disclosed system comprises multiple processors to perform the computing requirements of the disclosed system.

The disclosed system and method comprise the generation of an audio file. An audio file is a file that permits the storage of audio information including information relating to words found in the file as well as information relating to the sound made, including but not limited to, tone, pitch, treble, bass, and volume. Audio file formats can include uncompressed audio formats, such as WAV, AIFF, AU, and PCM. Audio file formats can include compressed formats such as lossless compression (FLAC, .ape), WavPack, TTA, ATRAC, ALAC, MPEG-4 SLS, MPEG-4 ALS, MPEG-4 DST, WMA Lossless, and Shorten and lossy compression, such as Opus, MP3, Vorbis, Musepack, AAC, ATRAC and WMA lossy.

Embodiments of the disclosed system and method include the use of output files that are simulated translations. The output file is also an audio file and can be output using the above audio file formats.

Further embodiments of the disclosed system and method include obtaining an audio file from a first language from phone calls, video calls, microphones, and any receiver that permits the transmission of sound. The disclosed system and method can utilize AI, generative adversarial networks, DeepFake systems to obtain audio files for translation into real-time translation simulation that mimics the emotion of the speaker. It should be noted that the disclosed system and method segregate text and audio information and recombine an accurate translation to yield appropriate emotional context within the audio simulation. Embodiments of the disclosed system and method include learning capability wherein the system improves its performance through corrective measures suggested by users and through access to online sources as language changes over time.

The disclosed system and method utilize a unique combination of processing power and modules executed to produce accurate, real-time simulation of how a human is speaking to mimic the emotion of the speaker in the translation simulation.

It should be noted that the disclosure is viewed from the perspective of the listener. However, from the perspective of the speaker, the number of languages that can be translated at any particular moment can be as great as the number of languages that exist. For example, a speaker at the United Nations would speak in their native language. The systems disclosed herein permit each listener to choose a language that they can understand. In this example, the speaker would be speaking to an audience of listeners in which hundreds of languages are spoken.

In another example, a wedding officiant would speak in their native language, while the listeners utilizing the disclosed system would select the language of their choosing. In this instance, the wedding officiant would be speaking their native language while dozens of languages could be chosen by the wedding attendees.

In another example, a television sporting event would be telecast. The telecast would be in a particular language. In the case of a sporting event such as the World Cup or Olympics, millions of viewers listening in hundreds of languages and thousands of dialects would be able to view the sporting event. As disclosed below, video displays would allow for images to mimic the language being spoken such that there would be a realism that the person doing the speaking is speaking the chosen language.

### 1. System

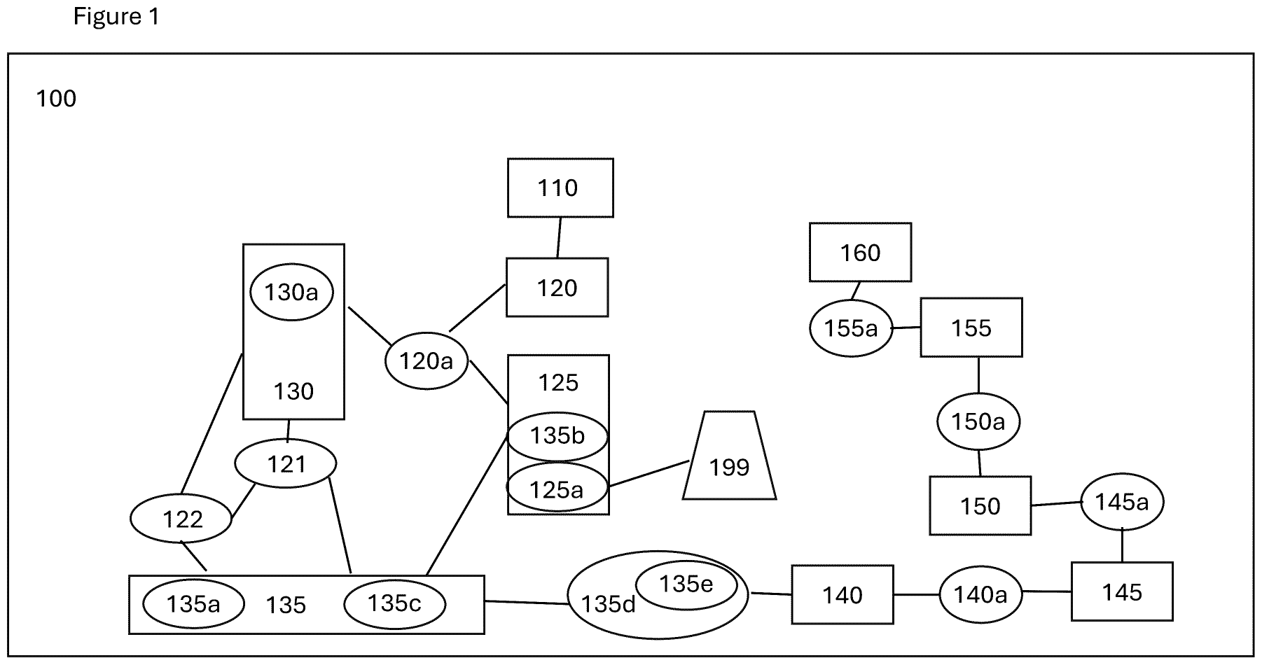

FIG. 1 shows an embodiment of the disclosed system. As shown in FIG. 1, the system 100 comprises a sound sensor module 110 configured to sense an audio signal that comprises a first language spoken by a source such as a human. The sound sensor module 110 is connected to a sound processing module 120 that converts the sound into an audio file 120a. The audio file 120a comprises the words, sounds, and emotional state of the speaker. The audio file 120a is stored in storage module 125 configured to store the audio file 120a of the first language. System 100 includes a segregation module 130. The segregation module 130 is activated upon receiving an input 130a from the storage module 125. The input 130a contains information that the audio file 120a has been received in the storage module 125. The segregation module 130 is configured to separate the audio file 120a into a plurality of distinct sections 121. The segregation module 130 can segregate the audio file by identifying word information and sound information. The segregation module 130 identifies individual elements of information to identify the plurality of distinct sections 121 and generating data 122 relating to words, phrases, pitch, tone, emotional state, volume, language tense, speaking speed, vocal strain, bass, and treble.

Upon generating data 122, the segregation module 130 sends data relating to words and phrases to transcription module 135, which is configured to create a transcript 135e of the plurality of distinct sections 121 and data 122. The transcription module 135 creates a first datafile 135a that comprises information on the words and phrases spoken by the user as well as details relating to the pitch, tone, emotional state, volume, language tense, speaking speed, treble, bass, and vocal strain identified in each of the plurality of distinct sections 121.

The transcription module 135 accesses storage module 125 to identify the language selected by user 199 from list 125a. List 125a comprises a list of languages stored in memory 125b of the system 100. The user 199 selects a second language from list 125a to which the user wishes the first language to be translated. List 125a is updated to ensure that the catalogue of languages is properly maintained. List 125a contains information relating to how words are used within the language, including the appropriate tense and word to match with the emotional state of the speaker.

The transcription module 135 further accesses a second datafile 135b stored in the memory 125b that contains information corresponding to pitch, tone, emotional state, volume, speaking speed, and vocal strain that should be used in the second language. The second datafile 135b is accessible by the transcription module 135 after the transcription module 135 identifies the appropriate emotional state based on comparing the plurality of distinct sections 121 to a third data file 135c that contains information about emotional state associated with similarly composed sounds stored in the third data file 135c. Upon identification of the appropriate emotional state after comparison of the second data file 135b to third data file 135c, the transcription module 135 selects the appropriate pitch, tone, emotional state, volume, language tense, speaking speed, treble, bass, and vocal strain to be used for a simulation.

The transcription module 135 sends a fourth data file 135d comprising a transcript 135e of the first language spoken by the speaker, information relating to the appropriate pitch, tone, emotional state, volume, language tense, speaking speed, treble, bass, and vocal strain to be used for a simulation as well as the second language to be used to translation module 140. Translation module 140 is configured to receive the transcript 135e from the transcription module 135 and further configured to create a translation transcript 140a from the transcript 135e in view of the second language selected by the user.

As shown in FIG. 1, the system 100 includes a conversion module 145 that is configured to receive the translation transcript 140a as well as to receive information relating to the appropriate pitch, tone, emotional state, volume, language tense, speaking speed, treble, bass, and vocal strain to be used for the simulation. Conversion module 145 converts the information relating to the appropriate pitch, tone, emotional state, volume, language tense, speaking speed, treble, bass, and vocal strain to be used for a simulation into meta information. The conversion module 145 further is configured to combine the meta information with the translation transcript 140a to match the appropriate pitch, tone, emotional state, volume, language tense, speaking speed, and vocal strain identified in each of the plurality of distinct sections 121. This becomes conversion transcript 145a.

Conversion module 145 communicates conversion transcript 145a to accuracy module 150. Accuracy module 150 is configured to scan the conversion transcript 145a for errors and to correct said errors. Accuracy module 150 corrects said errors by accessing accuracy language list 150b, which contains a list of common errors and the proper correction. Accuracy language list 150b further contains a list of terms, including synonyms and antonyms, to be used within the second language for particular emotional contexts. Upon determining that the transcript is accurate, accuracy module 150 generates accuracy transcript 150a.

Accuracy module 150 communicates accuracy transcript 150a to simulation module 155. The accuracy module 150 further communicates meta data relating to the appropriate pitch, tone, emotional state, volume, language tense, speaking speed, and vocal strain identified in each of the plurality of distinct sections 121 to simulation module 155. Simulation module 155 is configured to receive accuracy transcript 150a and generate a real-time simulation translation 155a that matches the pitch, tone, emotional state, volume, language tense, speaking speed, and vocal strain of the speaker. The simulation module 155 creates simulation translation 155a by reconstructing the appropriate pitch, tone, emotional state, volume, language tense, speaking speed, and vocal strain identified in each of the plurality of distinct sections 121 into a uniform audio file 155b and layering the audio file 155b over the accuracy transcript 150a to generate simulation translation 155a.

The simulation translation 155a is communicated to device 160. Device 160 is configured to recite the simulation translation 155a in accordance with the text of the translation as well as mimicking the emotional state of the speaker. Device 160 can be a laptop computer, earpiece, headphone, cell phone, landline phone, tablet, and any electronic device configured to play an audio file and receive audio file information.

Aspects of the disclosed systems include systems that provide video simulated translations. As shown in FIG. 1, a video module 170 receives a video data input 170a, wherein the video data input 170a comprises information relating to video images being received by a video device 175. In certain embodiments, the video device is a television, cell phone, tablet, computer, or other device capable of receiving and displaying videos.

Upon receiving video input 170a, the video module 170 stores the video input 170a in storage module 125. Storage module 125 transmits video input 170a to video segregation module 180 for segregating the video input 170a into snapshot components 170b. The video segregation module 180 transmits the snapshot components 170b to video compilation module 185. Video compilation module 185 communicates with simulation module 155 to receive simulation translation 155a. Video compilation module 185 compares the simulation translation 155a to the snapshot components 170b and adjusts snapshot components 170b to mimic the simulation translation 155a to create video simulation 185a.

Video compilation module 185 transmits video simulation 185a and simulation translation 155a to video simulation translation module 190 to overlay the simulation translation 155a on video simulation 185a and to ensure a realistic video translation, which becomes video simulation translation 190a.

In the case of a television show or other video, video simulation translation module 190 transmits video simulation translation 190a to device 160 for showing. It should be noted that the device 160 can be configured to have a delay of 1 or more seconds permit the creation of video simulation translation 190a.

### 2. Method

Aspects disclosed herein include a method of generating a real-time translation from a first language to a second language to maintain emotional fidelity from the first language to the second language.

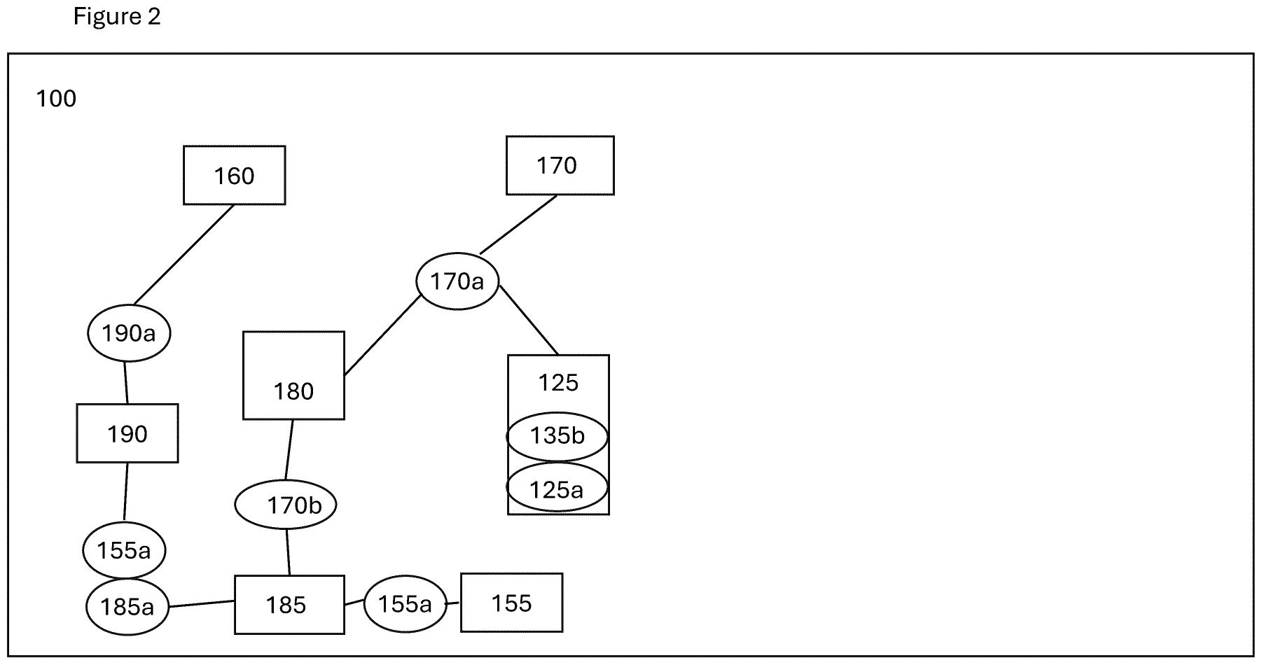

As shown in FIG. 2, the method comprises acquiring 210 and storing 220 an audio file of the first language as it is spoken by a person. The audio file can be obtained from a variety of sources including public speaking, microphones, telephones, cell phones, tablets, computer audio systems, and other technologies that generate audio.

The method further comprises segregating 230 the audio file into a plurality of distinct sections. Each of the plurality of distinct sections comprises data, said data comprising words and data relating to pitch, tone, emotional state, volume, language tense, speaking speed, treble, bass, and vocal strain. The step of segregating 230 involves separating the individual components of the audio file in distinct sections such that the data is separable into individual sounds on the one hand and individual words or parts of words on the other.

The method includes creating a transcript 240 from each of the plurality of distinct sections. Creating a transcript 240 involves creates a first datafile that comprises information on the words and phrases spoken by the user as well as details relating to the pitch, tone, emotional state, volume, language tense, speaking speed, treble, bass, and vocal strain identified in each of the plurality of distinct sections.

Creating a transcript 240 further involves identifying the language 250 to be translated to. In embodiments, a user selects the language from a list of available languages. The list of languages can be accessed by the user through a dialog box on a user interface. Alternatively, the user can access the list of languages through voice interfaces.

The list of languages also can be updated via internet to ensure that the languages on the list are up to date. The list also includes information relating to how words are used within the language, including the appropriate tense and word to match with the emotional state of the speaker. The list further includes information about how words should be used in particular emotional contexts and how words should be used in phrases when used in particular emotional contexts.

Aspects of the method includes creating a first datafile 250 with details relating to the pitch, tone, emotional state, volume, language tense, speaking speed, and vocal strain identified in each of the plurality of distinct sections. The method further includes, upon selection of a second language by a user, accessing a dataset 260 relating to the second language. In some embodiments, the dataset comprises words.

The method further includes, upon selection by the user of the second language, accessing a second datafile 270 corresponding to pitch, tone, emotional state, volume, language tense, speaking speed, and vocal strain used in the second language. In certain embodiments, the method further includes translating the transcript to the second language 280 by matching the transcript 290 with the dataset to create a translation transcript of the plurality of distinct sections.

In some embodiments, the matching of the transcript 290 involves converting the first datafile into meta information by matching the information in the first datafile with information in the second datafile. In other embodiments, the method further involves combining the meta information with the translation transcript to match the appropriate pitch, tone, bass, treble, emotional state, volume, language tense, speaking speed, and vocal strain identified in each of the plurality of distinct sections.

In other embodiments, the matching of the transcript 290 involves originating a transcript of the first language spoken by a speaker and providing information relating to the appropriate pitch, tone, emotional state, volume, language tense, speaking speed, treble, bass, and vocal strain to be used for a simulation as well as selecting the second language to be used to generate the translation transcript. The translation transcript includes all of the information necessary to generate a simulation, including the transcript of the second language and the data relating to the pitch, tone, bass, treble, emotional state, volume, language tense, speaking speed, and vocal strain.

Aspects of the method further includes confirming the accuracy of the translation transcript 291. In some embodiments, this is accomplished by scanning the translation transcript 292 for errors and correcting the errors 293. Errors are corrected by accessing accuracy language list 294, which contains a list of common errors and the proper correction. An accuracy language list contains a list of terms, including synonyms and antonyms, to be used within the second language for particular emotional contexts.

When the translation transcript is determined to be accurate, the method further involves generating a real-time simulation 295 matching the pitch, tone, bass, treble, emotional state, volume, language tense, speaking speed, and vocal strain of the person. The real-time simulation matches the pitch, tone, emotional state, volume, language tense, speaking speed, and vocal strain of the speaker and layers the audio onto the transcript to generate the real-time simulation.

In particular embodiments, the method further comprises sending the real-time simulation to a device of a user. The device can be a laptop computer, earpiece, headphone, cell phone, landline phone, tablet, and any electronic device configured to play an audio file and receive audio file information. Furthermore, the device can be configured to permit a user to access the language list using verbal commands, a dialog box, or any other method to access the language list.

The present system and method can be used in a variety of situations. Weddings, meetings, international events, sporting events, museums, schools, universities, and social gatherings. It should be noted that the present system and method are useful so long as the system can receive an audio signal. In other words, the speaker of the first language does not need to use a particular technology so long as the speaker can be sensed by the system.

The disclosed system and method are not restricted to the details of any foregoing embodiments. The disclosed system and method extend to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

I claim:

1. A system of generating a real-time translation from a first language to a second language to maintain emotional fidelity from the first language to the second language, the system comprising hardware and software such that the system comprises a sound sensor module configured to sense an audio signal; the system further comprising a sound processing module configured to convert the audio signal into an audio file; wherein the audio file comprises sounds selected from the group consisting of pitch, tone, emotional state, volume, language tense, speaking speed, treble, bass, and vocal strain; the system further comprising a storage module configured to store the audio file of the first language; the system further comprising a simulation module configured to generate a real-time simulation translation that matches the pitch, tone, bass, treble, emotional state, volume, language tense, speaking speed, and vocal strain of the speaker, wherein the real-time simulation translation further comprises an accurate transcript translating the first language of the speaker into the second language.

2. The system of claim 1, wherein the system further comprises a segregation module configured to separate the audio file into a plurality of distinct sections.

3. The system of claim 2, wherein the segregation module is activated upon receiving an input from the storage module.

4. The system of claim 2, wherein the segregation module identifies individual elements of information to identify the plurality of distinct sections and further generates data relating to words, phrases, pitch, tone, emotional state, volume, language tense, speaking speed, vocal strain, bass, and treble.

5. The system of claim 2, wherein the segregation module identifies word information and sound information.

6. The system of claim 1, wherein the system further comprises a transcription module configured to create a transcript 135e of the plurality of distinct sections and data.

7. The system of claim 5, wherein the transcript module is configured to create a first datafile that comprises information on the words and phrases spoken by the user as well as details relating to the pitch, tone, emotional state, volume, language tense, speaking speed, treble, bass, and vocal strain identified in each of the plurality of distinct sections.

8. The system of claim 5, wherein the transcript module is configured to access a language list.

9. The system of claim 8, wherein a user selects the second language from a memory.

10. The system of claim 8, wherein the list is updated to ensure that the catalogue of languages is properly maintained.

11. The system of claim 8, wherein the list contains information relating to how words are used within the language.

12. (canceled)

13. The simulation module 155 creates simulation translation 155a by reconstructing the appropriate pitch, tone, emotional state, volume, language tense, speaking speed, and vocal strain identified in each of the plurality of distinct sections 121 into a uniform audio file 155b and layering the audio file 155b over the accuracy transcript 150a to generate simulation translation 155a.

14. The system of claim 5, wherein the transcription module accesses a second datafile stored in a memory that contains information corresponding to pitch, tone, emotional state, volume, speaking speed, and vocal strain that should be used in the second language.

15. The system of claim 5, wherein the transcription module, upon identification of the appropriate emotional state after comparison of the second data file to a third data file selects the appropriate pitch, tone, emotional state, volume, language tense, speaking speed, treble, bass, and vocal strain to be used for a simulation.

16. The system of claim 5, wherein the transcription module sends a fourth data file comprising a transcript of the first language spoken by the speaker, information relating to the appropriate pitch, tone, emotional state, volume, language tense, speaking speed, treble, bass, and vocal strain to be used for a simulation as well as the second language to be used to a translation module.

17. The system of claim 16, wherein the translation module is configured to receive the transcript from the transcription module and further configured to create a translation transcript from the transcript in view of the second language selected by the user.

18. The system of claim 17 further comprising a conversion module that is configured to receive the translation transcript and to receive information relating to the appropriate pitch, tone, emotional state, volume, language tense, speaking speed, treble, bass, and vocal strain to be used for a simulation.

19. The system of claim 18, wherein the conversion module converts the information relating to the appropriate pitch, tone, emotional state, volume, language tense, speaking speed, treble, bass, and vocal strain to be used for a simulation into meta information.

20. The system of claim 18, wherein the conversion module is configured to combine the meta information with the translation transcript to match the appropriate pitch, tone, emotional state, volume, language tense, speaking speed, and vocal strain identified in each of the plurality of distinct sections to create a conversion transcript.

21. The system of claim 20 further comprising an accuracy module configured to scan the conversion transcript for errors and to correct said errors.

22. The system of claim 21, wherein the accuracy module comprises a list of terms, including synonyms and antonyms, to be used within the second language for particular emotional contexts.

23. The system of claim 21, wherein the accuracy module generates accuracy transcript.

24. The system of claim 23 further comprises a simulation module configured to receive the accuracy transcript and generate a real-time simulation translation that matches the pitch, tone, emotional state, volume, language tense, speaking speed, and vocal strain of the speaker.

25. The system of claim 24, wherein the simulation module creates a simulation translation by reconstructing the appropriate pitch, tone, emotional state, volume, language tense, speaking speed, and vocal strain identified in each of the plurality of distinct sections into a uniform audio file and layering the audio file over the accuracy transcript to generate the simulation translation.

26. The system of claim 25 further comprises a device to receive and recite the simulation translation.

27. The system of claim 26, wherein the device is selected from the group consisting of a laptop computer, an earpiece, a headphone, a cell phone, a landline phone, a tablet, and an electronic device configured to play an audio file and receive audio file information.

28. The system of claim 1 further comprises a video module that receives a video data input 170a, wherein the video data input comprises information relating to video images being received by a video device.

29. The system of claim 28, wherein the video device is a television, cell phone, tablet, computer, or other device capable of receiving and displaying videos.

30. The system of claim 28, wherein the video module, upon receiving video input, stores the video input in storage module.

31. The system of claim 28 further comprises a video segregation module for segregating the video input into snapshot components.

32. The system of claim 31, wherein the video segregation module transmits the snapshot components to video compilation module.

33. The system of claim 31 further comprises a video compilation module communicates with simulation module to receive simulation translation.

34. The system of claim 33 further comprises simulation translation to create a video simulation translation.

35. A method of generating a real-time translation from a first language to a second language to maintain emotional fidelity from the first language to the second language, the method comprising:
a. acquiring and storing an audio file of the first language as it is spoken by a person;
b. segregating the audio file into a plurality of distinct sections, wherein each of the plurality of distinct sections comprises data, said data comprising words and data relating to pitch, tone, emotional state, volume, language tense, speaking speed, and vocal strain;
c. creating a transcript from each of the plurality of distinct sections;
d. creating a first datafile with details relating to the pitch, tone, emotional state, volume, language tense, speaking speed, and vocal strain identified in each of the plurality of distinct sections;
e. upon selection of a second language by a user, accessing a dataset relating to the second language, wherein the dataset comprises words
f. upon selection by the user of the second language, accessing a second datafile corresponding to pitch, tone, emotional state, volume, language tense, speaking speed, and vocal strain used in the second language;
g. translating the transcript to the second language by matching the transcript with the dataset to create a translation transcript of the plurality of distinct sections;
h. converting the first datafile into meta information by matching the information in the first datafile with information in the second datafile;
i. combining the meta information with the translation transcript to match the appropriate pitch, tone, emotional state, volume, language tense, speaking speed, and vocal strain identified in each of the plurality of distinct sections;
j. confirming the accuracy of the translation transcript;
k. generating a real-time simulation matching the pitch, tone, emotional state, volume, language tense, speaking speed, and vocal strain of the person; and
l. sending the simulation to a device of a user.

36. The method of claim 28, wherein the device is selected from the group consisting of a laptop computer, an earpiece, a headphone, a cell phone, a landline phone, a tablet, and an electronic device configured to play an audio file and receive audio file information.
